(19) United States
(12) Patent Application Publication
(10) Pub. No.: US 2004/0164873 A1
(43) Pub. Date: Aug. 26, 2004

(54) Indicator device

(76) Inventor: Steven K. Lee, Minneapolis, MN (US)

Correspondence Address: Beck & Tysver, P.L.L.C., Suite 100, 2900 Thomas Avenue S., Minneapolis, MN, 55416, US

(21) Appl. No.: 10/372,878

(22) Filed: Feb. 24, 2003

(51) Int. Cl. G08B 5/00

(52) U.S. Cl. 340/815.4

(57) ABSTRACT

The present disclosure is directed to an indicator device that can provide a single output where, in the past, two or more indicator lights were needed. The indicator device works with an electronic device that has two or more binary components, each component having two binary states. Two or more indicator lights generate a light scheme that corresponds to the status of the states. A single output is created out of the light scheme in the form of an output light. For example, the indicator device includes a two or more light sources including a first light source coupled to the first component and a second light source coupled to the second component. The first light source generates a light when the first component is in the first binary state. Also, the first light source does not generate a light when the first component is in the second binary state. Further, the second light source generates a light when the first component is in the first binary state and the second component is in the first binary state. The indicator device also includes a light transmitter. The light transmitter is adapted to converge the generated light of the first and second light sources into a single visible output light when the first and second components are in their first binary states.

### BACKGROUND

The present disclosure relates to indicator devices. More specifically, the present disclosure relates to indicator devices using light to indicate a function such as “power on” in electronic devices such as personal computers.

Electronic devices such as personal computers and computer peripherals are ubiquitous. And manufactures continue to design and build new and improved products for sale to consumers. Personal computers include both desktop and laptop models. Desktop models typically include a housing containing various electronic parts such as processors, magnetic disk drives, optical disc drives, network cards, or the like. The desktop computer typically has a separate monitor, keyboard and mouse that are electrically coupled to the parts within the housing. Laptop computers typically include the electronic parts, display, keyboard, and a pointing device all within the same compact housing. Computer peripherals include external modems, printers, scanners, or the like. Computer manufacturers are constantly trying to develop computers and computer peripherals that make efficient use of space, are cost effective, are user friendly, and are aesthetically pleasing.

One example of a user friendly aspect of a personal computer are its indicator devices. For instance, many computers include an indicator device to indicate whether the power to the computer is on. Many computers also include another indicator device to indicate when the magnetic disk drive is reading or writing as opposed to being idle. Still another indicator device on a computer can indicate whether the optical drive is reading or writing as opposed to being idle. These indicator devices help inform the user if the computer or its software are working correctly. Each indicator devices typically includes a single light source that turns on and off to indicate the state of the corresponding function. Indicator devices for computers are generally low cost items in order to maintain the cost effectiveness of the computer design

One dilemma that has faced computer manufacturers is how to maintain the user friendly advantage of indicator lights while having the freedom to produce an aesthetically pleasing and low cost design. In some instances, this dilemma is compounded where a simple design is more than just pleasing to the eye but is also functional as in the case of the design of an efficient laptop computer. Laptop designers are often working under constraints such as size and weight, as well as efficient use of the size and weight, of the computer. For instance, laptop users might prefer larger keyboards and displays in an otherwise smaller computer. In this case, much of the surface area of the computer should be for the keyboard and display and thus less surface area of the computer is available for items such as multiple indicator lights. Even in the case of desktops, a user who has placed the computer in an open area of the home may prefer that the computer not be an eyesore to occupants of the home or their guests. One complaint of computer users is that multiple indicator lights make the computer design look busy, rather than sleek or efficiently constructed.

Some computer manufacturers have solved the problems of multiple indicator lights on some models by either removing the indicator lights altogether from the design, or obscuring the lights with a nearly opaque cover. Others recognize that indicator lights are beneficial on some models and obscuring the lights or leaving them out of the design are not an option. Thus, there exists a need in the art for an indicator device that is cost efficient, aesthetically pleasing, and does not require much surface area on the computer to be effective.

### SUMMARY

The present disclosure is directed to an indicator device that can provide a single output where, in the past, two or more indicator lights were needed. This device provides the computer designer with the ability to devote less surface area of the electronic device to indicator lights. Also, the user is able to look to one indicator light instead of two or more, for information regarding the status of the electronic device.

The indicator device works with an electronic device that has two or more binary components, each component having two binary states. One example of a binary component is whether the electronic device is on or off. In a computer, another binary component is whether the disk drive is reading or writing as opposed to being idle. The binary states in the first example are on and off. In the second example the binary states are read/write or idle. The status of the states is provided to the indicator device. Two or more indicator lights generate a light scheme that corresponds to the status of the states. A single output is created out of the light scheme in the form of an output light.

In one aspect, the indicator device includes a two or more light sources including a first light source operably coupled to the first component and a second light source operably coupled to the second component. Examples of light sources are set forth below. The first light source generates a light when the first component is in the first binary state. Also, the first light source does not generate a light when the first component is in the second binary state. Further, the second light source generates a light when the first component is in the first binary state and the second component is in the first binary state. The indicator device also includes a light transmitter, examples of which are described below. The light transmitter is adapted to converge the generated light of the first and second light sources into a single visible output light when the first and second components are in their first binary states.

### BRIEF DESCRIPTION OF THE FIGURES

FIG. 1 shows a perspective view of an environment of an indicator device.

FIG. 2 shows a block diagram of the indicator device of FIG. 1.

FIG. 3 shows a block diagram of an example of the indicator device of FIG. 1 in combination with components of an electronic device.

FIG. 4 shows a block diagram of another example of the indicator device of FIG. 1 in combination with components of an electronic device.

FIG. 5 shows a perspective and schematic view of an example of the indicator device corresponding with FIG. 2.

### DESCRIPTION

This disclosure relates to an indicator device adapted for use with an electronic device. The disclosure, including the figures, describes the indicator device with reference to a several illustrative examples. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

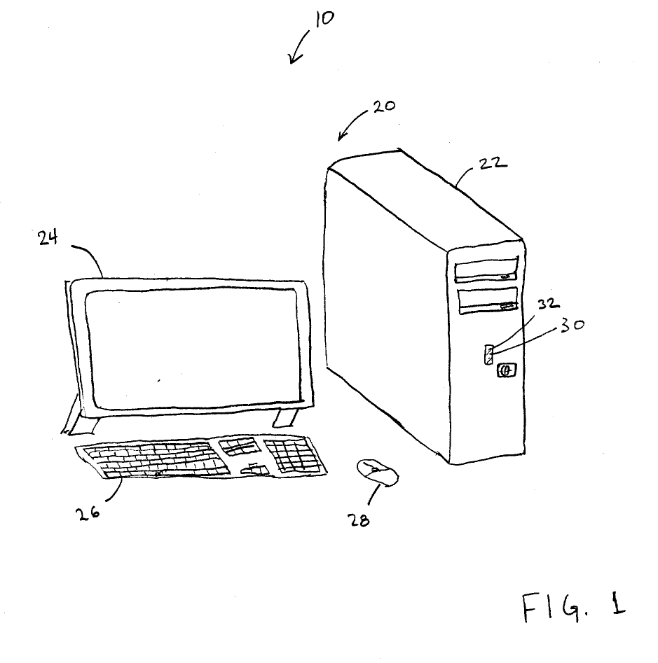

FIG. 1 shows an example of an electronic device 10 that is one general environment of a device of the present disclosure. The example of the electronic device in the figure is a computer 20. The computer 20 includes a housing 22 that can include a central processing unit with related circuitry, one or more magnetic disk drives, one or more optical disc drives, and circuitry to connect the computer to a network. The computer 20 also includes a display device 24 such as a monitor, an input device 26 such as a keyboard, and a pointing device 28 such as a mouse. In the example shown, the display device 24, input device 26 and pointing device 28 are electrically coupled to circuitry within the housing 22. Other configurations of the computer are known and contemplated to be within the scope of the disclosure.

Also, other examples of electronic devices 10 are contemplated. Such examples not shown include a printing device such as a printer, or an imaging device such as a scanner that are compatible with a computer, or storage devices such internal or external magnetic disk drives or optical drives. Virtually any electronic device, whether compatible with a computer, where a designer desires to indicate at least two binary functions through a single output can serve as an environment for the present disclosure.

In FIG. 1, the housing includes an indicator device 30. In the figure, the housing 22 has an opening 32, such as an aperture or a translucent window. The device 30 is disposed within the housing and proximate the opening 32. For example, the device 30 can partially extend through the aperture or be positioned next to the window. The indicator device produces a light that is visible to an observer near the housing 22.

Throughout this disclosure, the definition of translucent includes transparent, i.e., transparent is a form of translucent. That is, something that is transparent is also translucent, and something that is defined as translucent includes transparent.

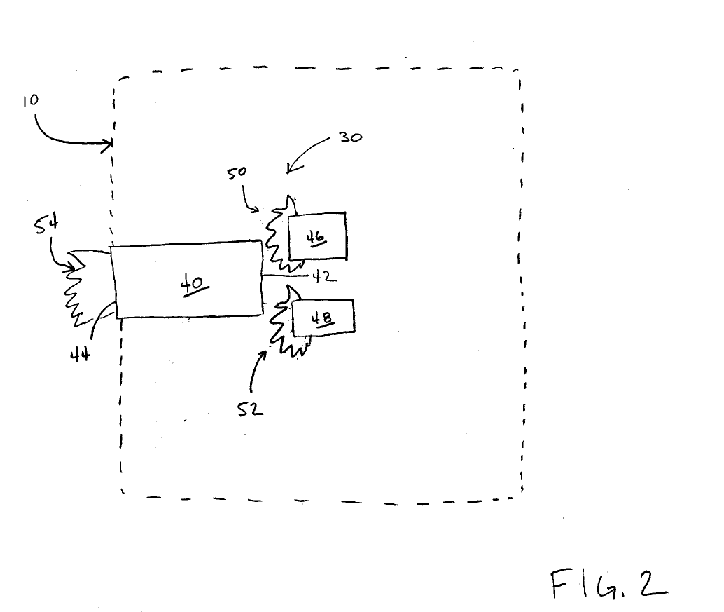

FIG. 2 shows a block diagram of the indicator device 30 in combination with the electronic device 10. The indicator device includes a light transmitter 40 having a light receiving end 42 and a light providing end 44. A plurality of light sources 46, 48, are disposed proximate the light receiving end 42. In the block diagram, two light sources 46, 48 are shown providing lights 50, 52, respectively. The use of more than two light sources is contemplated and within the scope of this disclosure.

Light sources 46, 48 are adapted to indicate binary states of functions of the electronic device 10 through the indicator device 30. For example, power is a binary function, either the power is on or it is off. Power on is one state of a binary function, and power off is anther state of the binary function. Light sources are adapted to be connected to circuitry associated with the electronic device 10 that provides an electrical signal to the light sources indicative of the functions. The electrical signal causes the light sources 46, 48 to generate light 50 and 52, respectively. Light 50 and 52 are provided to the light transmitter 40 at the light receiving end 42. At least some of the light 50, 52 enters the light receiving end 42. Light 50 and 52 are converged within the light transmitter 40 and provided as an output light 54 emanating from the light providing end 44 to be viewed by an observer 55. At least some of the light entering the transmitter 40 is output. The output light 54 appears to an observer as if light 54 is emanating from a single source.

The indicator device 30 can be constructed from various combinations of known elements. The light sources 46, 48 can include light bulbs, light emitting diodes, lasers such as semiconductor lasers, organic light-emitting displays (OLEDs), or the like. The light transmitter 40 can include any number of light convergence elements such as prisms, diffusers, light guides, light pipes, optical film, fiber optic articles, or the like.

A basic application of the indicator device 30 is explained with reference to the following first illustrative example. In the first illustrative example, one of the light sources such as light source 46 is adapted to indicate the power on function, i.e., to indicate whether the device 10 is turned on. Circuitry within the electronic device 10 is connected to the light source 46 that provides an electrical signal to the light source when the device 10 is turned on. The other of the light sources, light source 48, is adapted to indicated whether the magnetic disk drive is in read/write mode, such as when the disk drive is reading information from or writing information to the magnetic disk, as opposed to idle mode. Circuitry within the electronic device 10 is connected to light source 48, and an electric 5 signal is provided to light source 48 whenever the disk drive is in read/write mode. Accordingly, light source 46 in the example provides a light 50 indicative of the device is power on, and light source 48 in the example provides a light 52 indicative of read/write mode.

In the first illustrative example, two binary functions are indicated 10 through a single output. One binary function is the power on function, i.e., power is either on or off. The other binary function is disk drive operation, i.e., the disk drive is either in read/write mode or it is in idle mode. (The disk drive operation can actually be separated into three binary functions: [1] the drive is writing or not, [2] the drive is reading or not, and [3] the drive is idle or not.) 1 5 Whether power is supplied to the light source depends on which binary state the corresponding function is in. Any light emanating from the light sources is provided through the light transmitter to produce the output light. In the case where light is emanating from more than one light source, the light is converged within the transmitter. The multiple functions are indicated in the single output 20 by adjusting the intensity of the output light, adjusting the color of the output light, or adjusting the combination of intensity and color.

The first illustrative example is now described where the multiple functions of power on and read/write mode are indicated as an output light 54 that varies in intensity. Light sources 46, 48 are configured to emanate light of 25 generally the same color, or generally the same wavelength. Light 50 emanates when power is on. Light 52 emanates when the disk drive is in read/write mode. A selected combination of indications from light sources 46, 48 (or more than two light sources) is a light scheme. The output light 54 for the light scheme corresponding with the combination of binary functions is as follows: (1) the 30 output light intensity is high when power is on and the disk drive is in read/write mode (both light sources are on), (2) the output intensity is low when the power is on and the disk drive is idle (one light source is on), and (3) no light is output from the indicator device 30 when the power is off neither light source is on.

A second illustrative example is similar to the first illustrative example except that the multiple functions of power on and read/write mode are indicated as an output light 54 that varies in color rather than in intensity. Light source 46 provides light 50 of a different wavelength than light 52 from light source 48. In other words, light source 46 provides light 50 that is a different color than light 52 from light source 48. Again, light 50 emanates when power is on, and light 52 emanates when the disk drive is in read/write mode. The output light 54 for the light schemes corresponding with the combination of binary function is as follows: (1) no light is output from the indicator device when the power is off, (2) the output light 54 is the color of light 50 when the disk drive is idle, and (3) the output light 54 is a third color when the power is on and the disk drive is in read/write mode.

Where color is used to indicate the functions, light sources may be chosen from the primary additive colors of light, i.e., red, green and blue. For example, when red and green are chosen the combination provides yellow; when red and blue are chosen, the combination yields magenta; and when blue and green are chosen the combination yields cyan. Thus if in the second illustrative example the light sources 46, 48 are red and green, respectively and are applied to the functions of power on and read/write mode, respectively, the output is as follows: (1) the output light is yellow when power is on and the disk drive is in read/write mode, (2) the output light is red when the power is on and the disk drive is idle, and (3) no light is output from the indicator device when the power is off.

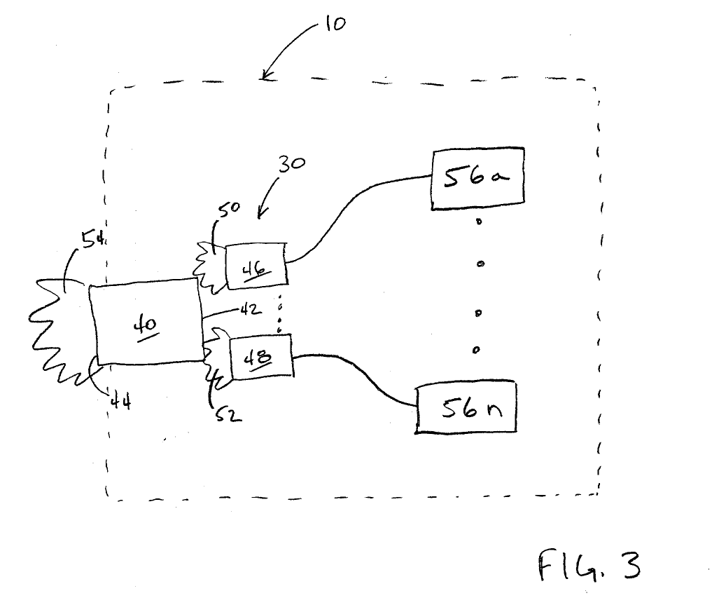

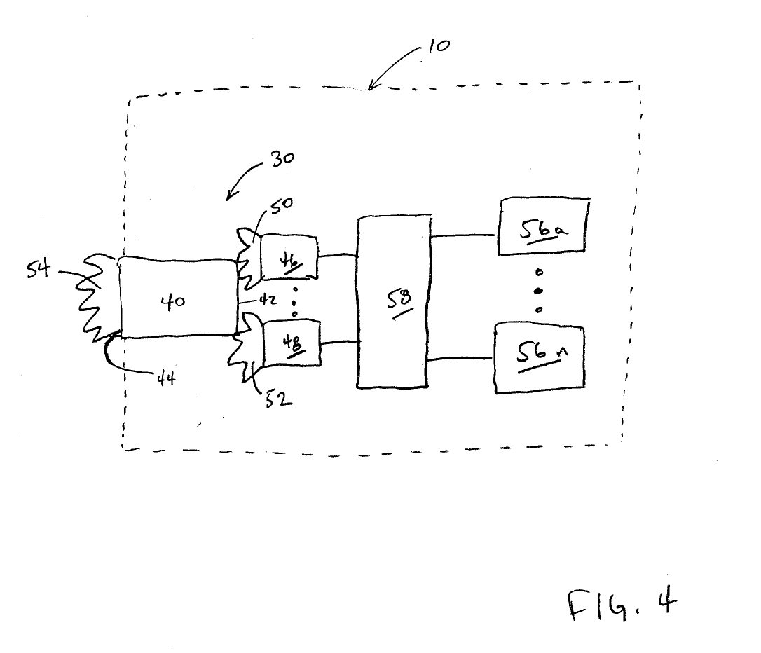

FIG. 3 and 4 are block diagrams showing the indicator device 30 connected to components of the electronic device 10. FIG. 3 shows the indicator device 30 directly connected to components 56a to 56n. As indicated, two or more components can be connected to the indicator device. The components need not include separate and distinct devices within the electronic device 10. Rather the components can each include a binary function, i.e., includes two binary states, of the electronic device 10. For example, one binary component can be power (power on or power off) and another component can be disk drive operation (disk drive read/write or disk drive idle). In another example, one element can be power on, another can be disk drive read, a third can be disk drive write, and a fourth can be disk drive idle. As described above, a single device such as disk drive can include one or more binary components. In this respect, binary components and binary functions are synonymous.

The binary state for the components are either user-selected, electronically selected, software selected, mechanically selected or chemically selected in a manner known in the art. The method or means used to select a binary state is not critical. Once the binary state is selected, the state is provided to the indicator device 30 from a component in a known manner.

FIG. 3 shows the indicator device 30 directly coupled to the components 56a-56n. This means that in the illustrated example that light source 46 is coupled to the power on circuitry, and that light source 48 is connected to the disk drive circuitry. This configuration is relatively straightforward and is particularly useful when the number of light sources in the indicator device 30 is equal to the number of components, or binary functions, connected to the indicator device 30.

FIG. 4 shows a logic device 58 interposed between the indicator device and the components 56a-56n. This configuration is particularly useful when the number of components exceeds the number of light sources. In a third illustrative example, a red and a green light source are connected to the three components of a disk drive. The binary components are indicated with lights 46, 48 as follows: (1) when the disk drive is reading, only the red light is on, (2) when the disk drive is writing, only the green light is on, and (3) when the disk drive is idle but the power is on, both the red light and green light are on. Thus, three binary components are indicated with two light sources through one output light: (1) the output light is red when the disk drive is reading, (2) the output light is green when the disk drive is writing, and (3) the output light is yellow when the drive is idle but the power is on.

The configuration of FIG. 4 is also useful to produce output light colors from the indicator device that are different than the colors of the light sources. One example uses three light sources with colors of red, green and blue: (1) the light sources emanating red and green are on when the disk drive is in read/write mode, thus the output light is yellow to indicate read/write mode, (2) the light sources emanating red and blue are on when the disk drive is idle but the power is on, thus the output light is magenta to indicate power on, and (3) no light is output when the power is off.

The logic device can also vary the intensity of the three additive primary colors of light to produce many different color of output light corresponding with different function. For example, the output color for read/write mode can be maroon and the output color for disk drive idle can be gold. The colors corresponding to the binary state of the components can be preselected at manufacture or can be selected by the user. In one example of a user selected light scheme, the user programs each color corresponding with a function at the electronic device. In another example of the user selected light scheme, the color scheme can be downloaded from a list of available light schemes. The color scheme can correspond with that of a favorite sports team, school, flag, or the like.

Logic device 58 can include a various electronic components such as a a series of logic gates or amplifiers now known to those skilled in the art, or simply hardwiring the components to the multiple components. For example the red light source can be directly coupled to the first and third component, and the green light source can be directly coupled to the second and third components.

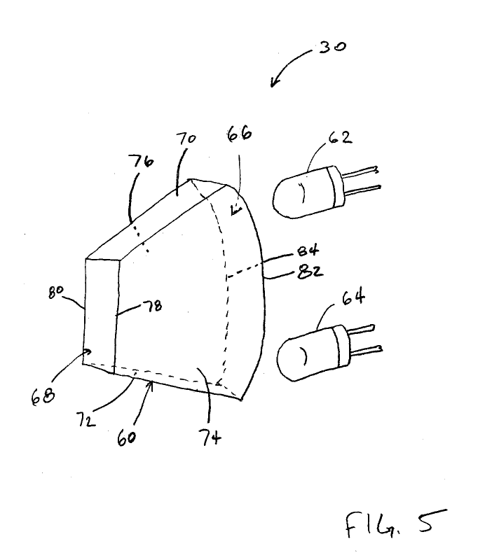

FIG. 5 shows a specific example of the indicator device 30 of FIG. 2. The indicator device 30 includes a translucent prism 60 corresponding with the light transmitter 44. The indicator device 30 also includes light sources 62, 64 corresponding with light sources 46, 48. The translucent prism 60 includes a light receiving end 66 and a light providing end 68. The light sources 46, 48 are disposed proximate the light receiving end 66. The prism also includes two generally opposite reflector sides 70, 72, and two generally opposite profile sides 74, 76.

In the disclosed example, the light receiving end 66 is diffusely transmissive, meaning that light is diffused more as it enters the light receiving end 66 than it would if the light receiving end was clear and smooth. For example, the light receiving end 66 can be roughened, frosted, coated, or the like, to become diffusely transmissive. In another example, the prism is molded to include a rough light receiving end 66 so that it is diffusely transmissive. In this example, the molded prism 60 includes a rougher texture at the light receiving end than it otherwise could through the molding technique.

In the example shown, the other surfaces 68, 70, 72, 74, 76 of the prism 60 are clear and smooth. The light providing end 68 is generally planar and generally opposite the light receiving end 66. The profile sides 74, 76 are generally shaped as a truncated sector. The profile sides 74, 76 each include a generally linear edge 78, 80, respectively, that is coextensive with the light providing end 68. The profile sides 74, 76 also each include a curvilinear edge 82, 84, respectively, that is coextensive with the light receiving end 66. In the example shown, the curvilinear edges 82, 84 are arcuate, which is a subset of curvilinear. The profile sides are generally wider at the curvilinear edges 82, 84, than they are at the linear edges 78, 80. The reflector sides 70, 72 in the example are generally planar, rectangular, and extend along the other edges of the profile sides 74, 76. In the example shown, the reflector sides are generally the same width as the light providing end 66 and the light receiving end 68.

Truncated sector is a broader definition of a shape than that typically understood to be a sector. For example, the tip of the “pie-shaped piece” looks as if were cut off to form the light providing end. The light providing end can be wide or narrow, and it can be as narrow as a pointed tip if the designer desires such a shape. The light providing end need not have a generally planar side 68. Also, the sector need not have sides 70, 72 that correspond with radii or curvilinear edges 82, 84 that correspond with an arc of a circle. A general shape of a wider curvilinear side and a narrower light providing end are contemplated to be within the scope of a truncated sector.

The light sources 62, 64 in the example are a pair of light-emitting diodes spaced apart from each other and placed proximate to the light receiving end 68. Each of the light sources are adapted to connect to circuitry of the electronic device 10 to provide an electrical signal to turn the light sources on. In the example shown, the light sources 62, 64 both emit a blue light.

Light entering the prism 60 at the light receiving end 68 is guided through the prism where the light exists the prism 60 at the light providing end 66. The diffusely transmissive light receiving end 68 provides for a more uniform and efficient output light than if the light providing end was clear and smooth. Likewise, the curved surface of light receiving end 68 in the example is particularly advantageous as it serves to capture and direct light in an efficient manner.

In the example, a substantial amount of surface area of the prism interfaces directly with the ambient air. Some surface area interfaces with connectors, such as clips or brackets, that couple the indicator device 30 to the housing 22 or other part of the electronic device 10 to hold the indicator 30 in place. However, a substantial prism to air interface is preferred, as now known in the art. The refractive index of the prism is chosen such that the light entering the prism 60 is totally internally reflected at the air/prism interface at sides 70, 72, 74, 76. Light inside the prim is directed toward the light providing end 66 where it exits the prism 60.

The prism can be constructed from a wide variety of materials that have an appropriate refractive index suitable for use as total internal reflector. In the example, the prism is cast or molded and thus the material selected is a thermoplastic resin. Suitable thermoplastic resins include polycarbonate or acrylics. Polycarbonate is a preferred material because of its high glass transition temperature and structural integrity. Polycarbonate is also readily available and readily inexpensive to manufacture. Further, the polycarbonate prism is relatively transparent (with the exception of the diffusely reflective light receiving end). If the electronic device is to be used in a location where it is exposed to elements, the light providing end can be covered with a polymethylmethacrylate (PMMA) film. Also, various hindered amine light stabilizers (HALS) and ultra violet protectors can be applied.

Various other forms of the prism 60 are contemplated. For example, the sides 70, 72, 74, 76 can include a deposited mirrored film. The mirroring promotes internal reflection in cases where too much light escapes from the sides 70, 72, 74, 76. Otherwise, total internal reflection is preferred. Total internal reflection is extremely efficient, whereas mirrors absorb light each time the light is incident on the mirrored film. In another example, the prism can be covered by a cladding.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details and structures described herein, but rather by the appended claims and equivalents.

What is claimed is:

1. An indicator device suitable for use with an electronic device, wherein the electronic device includes a plurality of components including first and second components, wherein each component includes first and second binary states, the indicator device comprising:
a plurality of light sources including a first light source operably coupled to the first component and a second light source operably coupled to the second component;
wherein the first light source generates a light when the first component is in the first binary state, and the first light source does not generate a light when the first component is in the second binary state;
wherein the second light source generates a light when the first component is in the first binary state and the second component is in the first binary state;
a light transmitter, the light transmitter adapted to converge the generated light of the first and second light sources into a single visible output light when the first and second components are in their first binary states.

2. The indicator device of claim 1 wherein the electronic device is one of a computer and a computer peripheral.

3. The indicator device of claim 2 wherein the components are disk drive read/write-or-idle and power on/off.

4. The indicator device of claim 3 wherein in the first binary state for the power on/off component is power on.

5. The indicator device of claim 2 wherein the components are selected from the group consisting of disk drive write/not-write, disk drive read/not-read, disk drive idle/not-idle and power on/off.

6. The indicator device of claim 1 wherein the plurality of light sources are selected from the group consisting of light bulbs, light emitting diodes, lasers, and organic light-emitting displays.

7. The indicator device of claim 1 wherein the light transmitter is selected from the group consisting of prisms, diffusers, light guides, light pipes, optical film, and fiber optic articles.

8. The indicator device of claim 1 wherein the output light varies in at least one of color and intensity.

9. An indicator device, comprising:
a translucent prism having a pair of opposite sides each configured as a truncated sector, each truncated sector having a curvilinear edge and an opposite edge;
a light receiving end including a diffusely transmissive side coextensive with the curvilinear edges;
a light providing end including a light output side coextensive with the opposite edges, the generally light output side opposite the prism from the diffusely transmissive side;
a first light source disposed proximate the diffusely transmissive side, the first light source adapted to selectively generate a first light, wherein at least some of the light from the first light source enters the prism at the light receiving end; and
a second light source disposed proximate the diffusely transmissive side, the second light source adapted to selectively generate a second light, wherein at least some of the light from the second light source enters the prism at the light receiving end;
wherein at least some of the light entering the prism at the light receiving end exits the prism at the light providing end.

10. The indicator device of claim 9 wherein the prism is transparent.

11. The indicator device of claim 9 wherein the curvilinear edge is arcuate.

12. The indicator device of claim 9 wherein the opposite edge is linear and the light output side is generally planar.

13. An indicator device, suitable for use with an electronic device having first and second binary components, each binary component having two states, the indicator device comprising:
a translucent prism having a pair of opposite sides each configured as a truncated sector, each truncated sector having a curvilinear edge and an opposite linear edge;
a light receiving end including a diffusely transmissive side coextensive with the curvilinear edges, the diffusely transmissive side adapted to diffuse light entering the prism;
a light providing end including a generally planar side coextensive with the linear edges, the generally planar side opposite the prism from the diffusely transmissive side;
a first light source disposed proximate the diffusely transmissive side, the first light source adapted to be coupled to the first component and to generate a light when the first component is in one of the binary states, and to not generate a light when the first component is in the other of the binary states;
wherein at least some of the light from the first light source enters the prism at the light receiving end; and
a second light source disposed proximate the diffusely transmissive side, the second light source adapted to be operably coupled to the second component and to generate a light when the second component is in one of the binary states, and to not generate a light when the second component is in the other of the binary states;
wherein at least some of the light from the second light source enters the prism at the light receiving end; and
wherein at least some of the light entering the prism at the light receiving end exits the prism at the light providing end.

14. The indicator device of claim 13 wherein the prism is polycarbonate.

15. The indicator device of claim 13 wherein the prism is molded to from the diffusely transmissive side.

16. The indicator device of claim 13 wherein the first and second light sources are spaced apart from each other.

17. The indicator device of claim 13 wherein a logic device is interposed between the first and second components and the light sources.

18. An indicator device for an electronic device, wherein the electronic device includes a plurality of components, each component capable of a pair of binary states, the electronic device comprising:
means for generating a selected binary state for each of the plurality of components;
a plurality of light sources generating a light scheme corresponding to the selected binary states of the plurality of components; and
means for receiving the light scheme and providing a single output with an output light source, the single output corresponding with the light scheme.

19. The electronic device of claim 18 wherein the indicator device includes three light sources.

20. The electronic device of claim 19 wherein the three light sources include a green light source, a red light source and a blue light source.

21. The electronic device of claim 20 wherein the light scheme includes a red light from the red light source and a green light from a green light source, and the output corresponding with the light scheme is a yellow light.

22. A method of indicating functions of an electronic device, wherein the electronic device includes a plurality of components, each component capable of a pair of binary states, the method comprising:
selecting a binary state for each of the plurality of components;
using a plurality of light sources to generate a light scheme corresponding to the selected binary states of the plurality of components; and
providing a single output with an output light source, the single output corresponding with the light scheme.
